(19) United States
(12) Patent Application Publication
(10) Pub. No.: US 2025/0206400 A1
(43) Pub. Date: Jun. 26, 2025

(54) TOOL WITH INTERFERENCE-FIT STRUCTURE

(71) Applicant: U-POWER COLLECTION ENTERPRISE CO., LTD., Taichung City (TW)

(72) Inventor: Perry TSAI, Taichung City (TW)

(21) Appl. No.: 18/980,485

(22) Filed: Dec. 13, 2024

(30) Foreign Application Priority Data
Dec. 20, 2023 (TW) 112149882

(51) Int. Cl. B62J 9/40; B62J 9/10; B62K 19/40

(52) U.S. Cl. CPC B62J 9/40; B62J 9/10; B62K 19/40

(57) ABSTRACT

A tool with an interference-fit structure includes a main body, an adjustment member, and an interference-fit member. One end of the main body is defined as a connecting end. The adjustment member is connected to the connecting end, with an adjustable distance formed between the connecting end and the adjustment member. The adjustment member can be moved with respect to the connecting end to adjust the adjustable distance. The interference-fit member is provided between the adjustment member and the connecting end, and the outer diameter of the interference-fit member can be changed by changing the adjustable distance. By adjusting the adjustable distance between the adjustment member and the main body, the outer diameter of the interference-fit member can be changed to achieve an effective interference fit between the interference-fit member and the inner wall of a tube, thereby securing the tool in the tube.

### FIELD OF THE INVENTION

The present invention relates to a tool and more particularly to a tool with an interference-fit structure that allows the tool to be tightly fit in tubes of different tube diameters.

### DESCRIPTION OF THE RELATED ART

On-vehicle bicycle tools are generally mounted on the frame of a bicycle (e.g., hung on the bicycle frame or put in a water bottle holder on the frame) to reduce the rider's load. For the sake of volume reduction, a bicycle tool may also be placed in a tube (e.g., the seat tube or the handle tube) of a bicycle frame. Conventionally, a tool to be put into a tube of a bicycle frame is provided with an elastic plug so that when the tool is placed in the tube, the elastic plug will be elastically engaged in the tube to achieve an interference fit.

The elastic plug of such a conventional tool is composed of one or a plurality of flexible discs whose elastic deformation produces the intended interference-fit effect. Having a fixed diameter, however, the elastic plug does not work in a tube whose tube diameter is greater than the diameter of the elastic plug. The elastic plug will not fit tightly in a tube with an overly large tube diameter, and the elastic plug tends to get stuck in, and therefore have problem being taken out of, a tube with too small a tube diameter. Moreover, the elastic plug is likely to deform after long-term use such that its interference-fit effect is reduced, meaning the elastic plug may eventually fail to secure the tool properly, which causes inconvenience of use.

### SUMMARY OF THE INVENTION

One objective of the present invention is to provide a tool having an interference-fit structure. The tool is provided with an interference-fit member that deforms when subjected to an applied force, and the deformation produces an interference fit-based positioning effect for the tool, allowing the tool to be tightly fit in a tube of a bicycle frame.

Another objective of the present invention is to provide a tool that has an interference-fit structure and that can be held in place in tubes of different tube diameters.

Still another objective of the present invention is to provide a tool that has an interference-fit structure whose interference-fit effect can be adjusted without using an additional auxiliary tool.

To achieve the above and other objectives, the present invention provides a tool having an interference-fit structure. The tool includes a main body, an adjustment member, and an interference-fit member.

The main body is an elongated body. One end of the main body is a connecting end.

The adjustment member is connected to the connecting end, an adjustable distance is formed between the connecting end and the adjustment member. The adjustment member can be moved with respect to the connecting end in order to adjust the adjustable distance.

The interference-fit member is a soft material provided between the adjustment member and the connecting end. The interference-fit member has an outer diameter, the outer diameter of the interference-fit member can be changed by changing the adjustable distance.

Thanks to the foregoing design, the present invention allows the outer diameter and interference-fit effect of the interference-fit member to be changed by adjusting the adjustable distance. The adjustment member can be operated directly by a user in order to change the outer diameter of the interference-fit member and thereby adjust the tightness of fit of the tool in a tube. The tool, therefore, can adapt to bicycle frame tubes of different sizes, and the tightness of fit of the tool in a tube can be adjusted without using an additional tool.

Preferably, the aforesaid end of the main body is threadedly connected with the adjustment member, the adjustable distance can be adjusted by rotating the adjustment member, and the interference-fit member is pressed by the main body and the adjustment member.

Preferably, the connecting end of the main body has an end face forming an abutting surface, the adjustment member has an end face facing the main body and forming a contact surface, the adjustable distance is formed between the abutting surface and the contact surface, and the interference-fit member is pressed by the abutting surface and the contact surface.

Preferably, the connecting end of the main body is protrudingly provided with a first protruding block, the end face of the adjustment member that faces the main body is provided with a second protruding block, and the interference-fit member is disposed on the first protruding block and the second protruding block.

When it is desired to put the tool into a tube of a bicycle frame, the main body can be easily inserted into the tube since the interference-fit member is not fully tightened. The outer diameter of the interference-fit member can then be changed by adjusting the adjustable distance, in order for the interference-fit member to achieve a proper interference fit in the tube that prevents the interference-fit member from falling out. As the outer diameter of the interference-fit member is adjustable, the tool can be held in place in tubes of different tube diameters (inner diameters). A user can change the outer diameter of the interference-fit member directly through the adjustment member.

Preferably, the end face of the adjustment member that faces the main body is protrudingly provided with a ring portion, and the ring portion has an end face forming the abutting surface.

Preferably, a washer is provided on the end face of the adjustment member, the contact surface and the ring portion are formed by the washer.

Preferably, the ring portion has an outer diameter equivalent to an outer diameter of the main body.

### BRIEF DESCRIPTION OF THE DRAWINGS

The objectives, features, and effects of the present invention can be better understood by referring to the following preferred embodiment in conjunction with the accompanying drawings, in which:

FIG. 1 is a perspective view of a tool of a preferred embodiment of the invention;

FIG. 2 is an exploded perspective of the embodiment shown in FIG. 1;

FIG. 3 is a side view of the embodiment shown in FIG. 1;

FIG. 4 is a longitudinal sectional view of the embodiment shown in FIG. 1;

FIG. 5 schematically shows how the tool shown in FIG. 1 is put into a tube, with the interference-fit member having yet to be tightly fit in the tube; and

FIG. 6 is similar to FIG. 5 except that the interference-fit member is tightly fit in the tube.

### DETAILED DESCRIPTION OF THE INVENTION

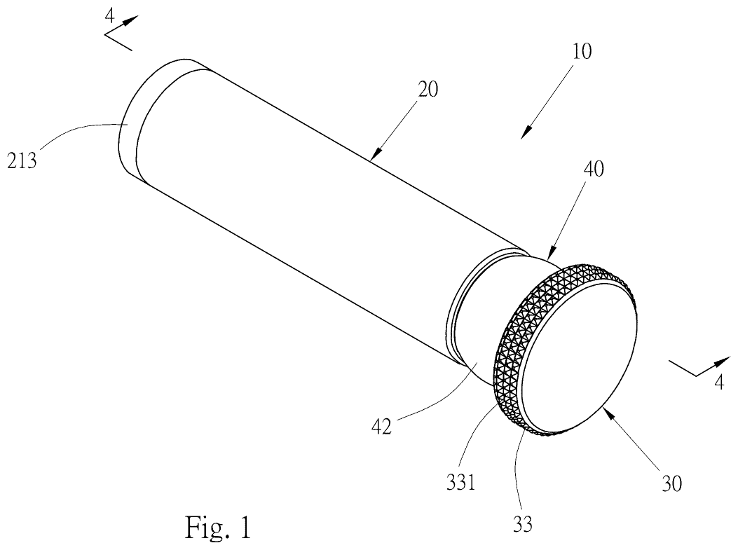

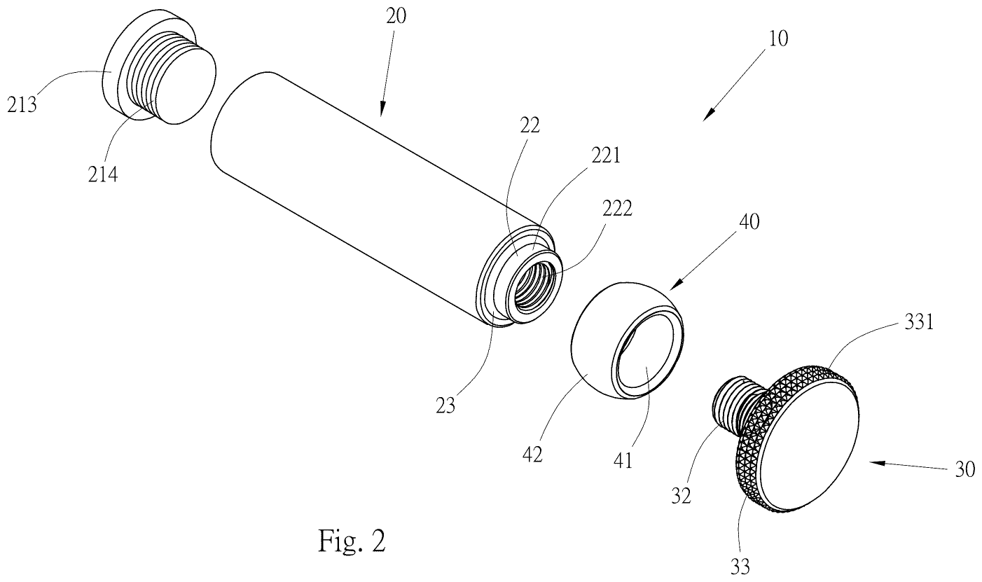

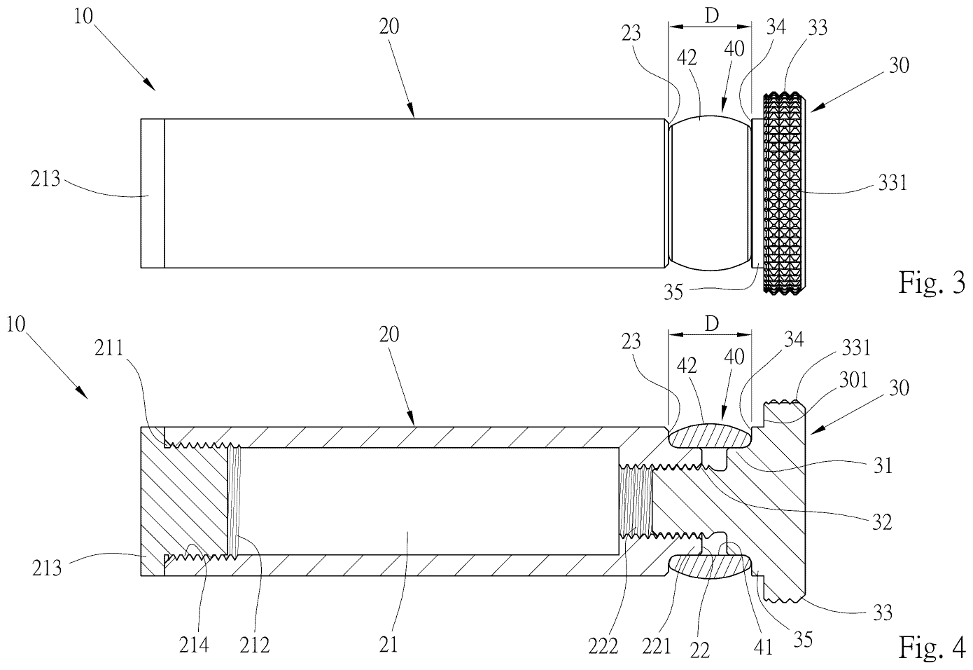

Referring to FIG. 1 to FIG. 4, a preferred embodiment of the present invention provides a tool 10 having an interference-fit structure. The tool 10 includes a main body 20, an adjustment member 30, and an interference-fit member 40.

The main body 20 is formed as an elongated tubular body provided therein with a receiving chamber 21. The receiving chamber 21 can be used to store one or several tools such as a repair tool or a chain removal/installation tool. Alternatively, at least one tool may be mounted directly on the main body 20, and the tool is not limited to being stored in the receiving chamber 21. One side of the receiving chamber 21 is provided with an open end 211, and the inner wall of the open end 211 of the main body 20 is provided with an internal thread 212. An end cover 213 with an external thread 214 closes the open end 211 of the main body 20 through threaded connection between the external thread 214 and the internal thread 212. When the end cover 213 is unscrewed, the tool (e.g., a repair tool) stored in the receiving chamber 21 can be taken out through the open end 211. The other end of the main body 20 opposite to the open end 211 is a connecting end 22. The connecting end 22 is protrudingly provided with a first protruding block 221, and a threaded hole 222 is provided in the connecting end 22 along the longitudinal direction of the main body 20. Preferably, the inner end of the threaded hole 222 is in communication with the receiving chamber 21. The first protruding block 221 protruding from the connecting end 22 has an outer diameter less than the outer diameter of the main body 20. The connecting end 22 of the main body 20 has an end face forming an abutting surface 23.

The adjustment member 30 has an end face (i.e., the inner end face) 301 facing the main body 20 and protrudingly provided with a second protruding block 31 and a threaded rod 32. The second protruding block 31 corresponds to the first protruding block 221 at the connecting end 22 of the main body 20, and the diameter of the second protruding block 31 is equivalent to the outer diameter of the first protruding block 221. The threaded rod 32 can be screwed into the threaded hole 222 such that the adjustment member 30 is threadedly connected to the connecting end 22 of the main body 20. The aforesaid end face (i.e., the inner end face 301) of the adjustment member 30 forms a contact surface 34. An adjustable distance D is formed between the connecting end 22 of the main body 20 and the adjustment member 30, or more particularly between the abutting surface 23 and the contact surface 34, and the adjustment member 30 can be rotated to move the threaded rod 32 gradually into or out of the threaded hole 222, thereby adjusting the adjustable distance D by moving the adjustment member 30 relative to the main body 20. The adjustment member 30 is further provided with a rotating portion 33. The diameter of the rotating portion 33 is greater than the outer diameter of the main body 20, and the rotating portion 33 is peripherally provided with a rough surface 331 to make it easier for a user to rotate the rotating portion 33. In this preferred embodiment, the inner end face of the adjustment member 30 is protrudingly provided with a ring portion 35. The outer diameter of the ring portion 35 is equivalent to the outer diameter of the main body 20, is less than the diameter of the rotating portion 33, and is greater than the diameter of the second protruding block 31. The ring portion 35 has an end face forming the contact surface 34. The second protruding block 31 is provided on the ring portion 35. Alternatively, a washer is disposed on the inner end face 301 of the adjustment member 30, the contact surface 34 and the ring portion 35 are formed by the washer. Alternatively, the second protruding block 31 is protruding from the inner end face 301 of the adjustment member, the contact surface 34 and the ring portion 35 are formed by a washer sleeved on the second protruding block 31.

The interference-fit member 40 is a soft and deformable material such as rubber and is provided between the adjustment member 30 and the connecting end 22 of the main body 20 in order to be pressed by, or squeezed between, the main body 20 and the adjustment member 30, especially the abutting surface 23 and the contact surface 34, with the outer diameter of the interference-fit member 40 varying with the adjustable distance D. The interference-fit member 40 is of an annular shape and has a through hole 41 extending along the axis of the interference-fit member 40. One side of the interference-fit member 40 is disposed on the first protruding block 221 at the connecting end 22, and the other side of the interference-fit member 40 is disposed on the second protruding block 31 of the adjustment member 30. The first protruding block 221 and the second protruding block 31 are spaced apart from, and hence do not contact, each other. The outer periphery of the interference-fit member 40 is provided with an interference-fit portion configured as a curved surface 42, and the curved surface 42 is changed when the adjustable distance D is changed. When the adjustable distance D is reduced, the interference-fit member 40 is squeezed to an increasing extent such that the outer diameter of the interference-fit member 40 is increased, and when the adjustable distance D is subsequently increased, the interference-fit member 40 is squeezed to a decreasing extent such that the outer diameter of the interference-fit member 40 is reduced. The outer diameter of the interference-fit member 40 will be greater than the outer diameter of the main body 20 when the interference-fit member 40 is squeezed.

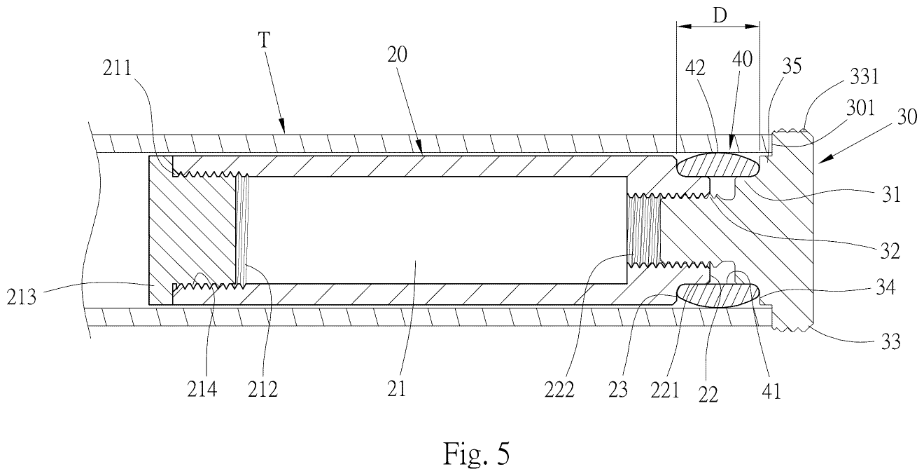

To place the tool 10 into a tube T of a bicycle frame, referring to FIG. 5, the first step is to increase the adjustable distance D by rotating the adjustment member 30 so that the interference-fit member 40 is not pressed or is only slightly pressed, the objective being for the interference-fit member 40 to have a relatively small outer diameter that allows the tool 10 to be put into the tube T with ease.

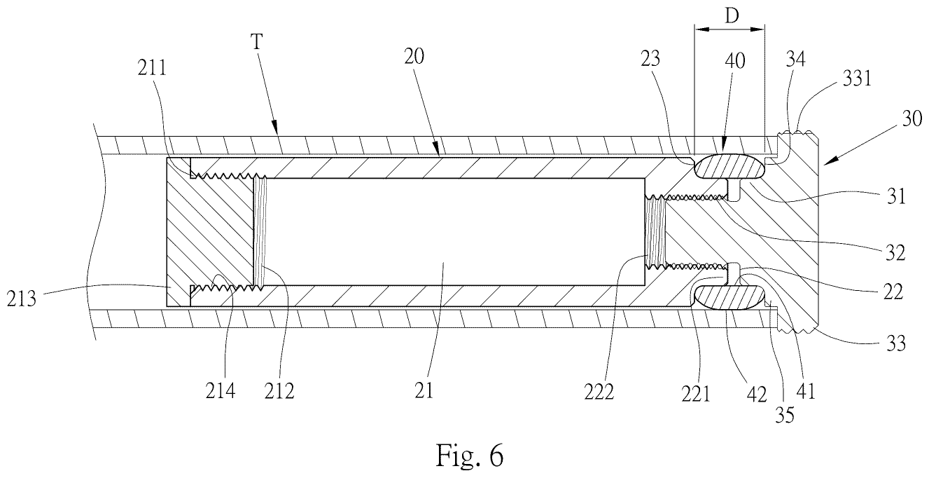

Once the tool 10 is completely put into the tube T, referring to FIG. 6, the rotating portion 33, whose diameter is the greatest of the diameters and outer diameters of all the components of the tool 10 and which therefore is exposed outside the tube T, is rotated to move the adjustment member 30 toward the main body 20, i.e., to make the contact surface 34 and the abutting surface 23 approach each other, so that the adjustable distance D is reduced. When the adjustable distance D is reduced, the interference-fit member 40 is pressed, or further pressed, by the contact surface 34 and the abutting surface 23, and the outer diameter of the curved surface 42 is gradually increased as a result. During the process, the curved surface 42 is gradually brought into contact with the inner surface of the tube T, causing elastic deformation of the interference-fit member 40, and in consequence, with the interference-fit member 40 tightly engaged in the tube T, the tool 10 is well secured in the tube T. The tightness with which the interference-fit member 40 is pressed against the tube T can be adjusted in a stepless manner according to user needs. A user only has to rotate the rotating portion 33 to fine-tune the outer diameter of the interference-fit member 40, and the optimal interference fit can be achieved for the tool 10. As the outer diameter of the interference-fit member 40 can be changed in a relatively large range, a desirable interference fit can be attained in tubes T of different inner diameters to hold the tool 10 in place.

To take out the tool 10, the rotating portion 33 is rotated in the opposite direction to increase the adjustable distance D, i.e., to move the contact surface 34 away from the abutting surface 23. When the extent to which the interference-fit member 40 is squeezed decreases, the outer diameter of the interference-fit member 40 is reduced such that the elastic interference fit between the interference-fit member 40 and the tube T no longer exists or is lessened, allowing the tool 10 to be taken out of the tube T easily. Once the tool 10 is taken out, the end cover 213 can be removed from the open end 211 so that the repair tool, for example, in the receiving chamber 21 can be pulled out for use. After using the repair tool and putting it back into the receiving chamber 21, the end cover 213 is threadedly connected to the open end 211, and the tool 10 is placed into the tube T as stated above.

It is worth mentioning that a user may adjust the outer diameter of the interference-fit member 40 to an appropriate extent before putting the tool 10 into the tube T to achieve an interference fit between the interference-fit member 40 and the inner wall of the tube T.

The adjustment member 30 can be rotated directly by a user in order to change the outer diameter of the interference-fit member 40 and thereby adjust the tightness of fit of the tool 10 in differently sized bicycle frame tubes. No additional tool is required for adjusting the tightness of fit of the tool 10.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. A tool with an interference-fit structure, comprising:
a main body formed as an elongated body and having an end defined as a connecting end;
an adjustment member connected to the connecting end, an adjustable distance is formed between the connecting end of the main body and the adjustment member, the adjustment member being movable with respect to the connecting end to adjust the adjustable distance; and
an interference-fit member formed of a soft and deformable material and provided between the adjustment member and the connecting end, the interference-fit member has an outer diameter that is changeable by changing the adjustable distance.

2. The tool as claimed in claim 1, wherein an abutting surface is formed on an end face of the connecting end of the main body, the adjustment member has an end face facing the main body and forming a contact surface, the adjustable distance is formed between the abutting surface and the contact surface, and the interference-fit member is located between and pressed by the abutting surface and the contact surface.

3. The tool as claimed in claim 1, wherein one end of the main body is threadedly connected with the adjustment member, the adjustable distance is adjustable by rotating the adjustment member, and the interference-fit member is pressed by the main body and the adjustment member.

4. The tool as claimed in claim 3, wherein the connecting end of the main body has an end face forming an abutting surface, the adjustment member has an end face facing the main body and forming a contact surface, the adjustable distance is formed between the abutting surface and the contact surface, and the interference-fit member is located between and pressed by the abutting surface and the contact surface.

5. The tool as claimed in claim 1, wherein the adjustment member has an end provided with a threaded rod, the connecting end of the main body is provided with a threaded hole, the threaded rod of the adjustment member is threadedly connected with the threaded hole, the adjustable distance is adjustable by rotating the adjustment member, the interference-fit member is pressed by the main body and the adjustment member, the interference-fit member is of an annular shape, and the threaded rod extends through the interference-fit member.

6. The tool as claimed in claim 1, wherein the connecting end of the main body is provided with a first protruding block, the adjustment member has an end face facing the main body and provided with a second protruding block, and the interference-fit member is disposed on the first protruding block and the second protruding block.

7. The tool as claimed in claim 2, wherein the connecting end of the main body is provided with a first protruding block, the adjustment member has an end face facing the main body and provided with a second protruding block, and the interference-fit member is disposed on the first protruding block and the second protruding block.

8. The tool as claimed in claim 1, wherein the interference-fit member is of an annular shape and has an outer periphery provided with an interference-fit portion.

9. The tool as claimed in claim 8, wherein the interference-fit portion is a curved surface.

10. The tool as claimed in claim 6, wherein the interference-fit member is of an annular shape and is sleeved on the first protruding block and the second protruding block.

11. The tool as claimed in claim 3, wherein the adjustment member has a rotating portion, and the rotating portion has a diameter greater than an outer diameter of the main body.

12. The tool as claimed in claim 1, wherein the main body is provided therein with a receiving chamber.

13. The tool as claimed in claim 5, wherein the main body is provided therein with a receiving chamber; the threaded hole has an inner end in communication with the receiving chamber.

14. The tool as claimed in claim 13, wherein the receiving chamber forms an open end at another end of the main body, and an end cover is detachably mounted at the open end of the main body.

15. The tool as claimed in claim 2, wherein the end face of the adjustment member that faces the main body is protrudingly provided with a ring portion, and the ring portion has an end face forming the abutting surface.

16. The tool as claimed in claim 15, wherein the ring portion has an outer diameter equivalent to an outer diameter of the main body.

17. The tool as claimed in claim 15, wherein a washer is provided on the end face of the adjustment member, the contact surface and the ring portion are formed by the washer.
